(19) United States
(12) Patent Application Publication
(10) Pub. No.: US 2023/0077135 A1
(43) Pub. Date: Mar. 9, 2023

(54) SYSTEMS AND METHODS FOR SUGGESTING DROP-BOX LOCATIONS

(71) Applicant: Caterpillar Inc., Peoria, IL (US)

(72) Inventor: Lucas Inoue Sardenberg, Oak Park, IL (US)

(21) Appl. No.: 17/470,616

(22) Filed: Sep. 9, 2021

(51) Int. Cl. G06Q 10/08; G06Q 30/02

(52) U.S. Cl. CPC G06Q 10/0836; G06Q 30/0206

(57) ABSTRACT

Systems and methods for suggesting drop-box locations include collecting data from one or more sensors or databases, determining equipment location trends and asset usage trends in a geographic area based on the data, determining a customer opportunity score for one or more pieces of equipment in a geographic area, and, using an algorithm with a plurality of factors, combining the equipment location trends and asset usage trends with the customer opportunity score to output a geographic location for a drop-box. In some embodiments, the plurality of factors can include at least one or more customer distances from the geographic location.

### TECHNICAL FIELD

The present disclosure relates to systems and methods for suggesting drop-box locations, including analyzing asset location trends and customer opportunities to generate recommendations for drop-box locations.

### BACKGROUND

Assets such as construction equipment are often sold and serviced by dealers. Each dealer may have rights to a dealer territory, within which the dealer may have several dealer locations for sales, service, parts, and other related activities. The dealer may also operate “drop-box” locations within the dealer territory. The drop-boxes can include small structures or receptacles (such as sheds or outbuildings, or other structures) for customers to retrieve new parts and/or relinquish old parts (e.g., “core” parts). Parts can include equipment components, lubricants, specialized tools, or other items related to the maintenance and/or repair of equipment. Equipment may include trucks, tracked-type tractors, excavators, wheel loaders, front-end loaders, vehicles, powered tools, and other equipment.

A dealer often positions the drop-boxes at locations that are convenient to a customer's location. Typically, for example, a dealer may position a drop-box near a customer's main office. An advantage of drop-boxes is that they reduce a customer's travel time to access new parts and/or trade the old parts. For example, a customer may only need to travel to the nearest drop-box instead of a dealer location, which may be farther away. Another advantage is that the drop-boxes may be accessible when the dealer location is closed, such as after-hours.

However, customers do not always operate and/or maintain their equipment at their main offices. For example, a customer may have a construction project located remotely from the main office. As a result, the customer's equipment may be located far from the drop-box location and far from a dealer location. The customer's location and/or the location of the customer's equipment can change over time. The dealer has other customers who have similar drop-box needs. Accordingly, there is a need for systems and methods that determine drop-box locations that are conveniently (e.g., optimally) located for a dealer's customers.

U.S. Patent Application Publication No. 2020/0250614 (hereinafter, “Zhu”) discloses a system that includes a plurality of electronic lockers. Couriers and recipients access the lockers to deliver and retrieve items. If a recipient changes location, the system can track the recipient and determine a new locker for the courier and recipient to access for delivery and retrieval of an item. Although Zhu's system relates to automating the selection of a new locker for a recipient to access, it fails to address optimal positioning of the locker itself. Accordingly, Zhu's system is not helpful in a construction context, where a customer's assets tend to stay in one general location for a relatively longer period of time and therefore it is more desirable to have the drop-box positioned near the customer. Zhu's system does not optimally position a locker near the recipient.

There remains a need for automatically suggesting drop-box locations based on the location of a customer and/or a customer's use of assets. Systems and methods according to embodiments of the present technology, as described herein, and variants thereof, are directed toward overcoming one or more of the deficiencies described above and/or other problems with the prior art.

### SUMMARY

In some embodiments, a method of determining a suggested location for a drop-box includes collecting data from one or more sensors or databases, determining equipment location trends and asset usage trends in a geographic area based on the data, determining a customer opportunity score for one or more pieces of equipment in a geographic area, and, using an algorithm with a plurality of factors, combining the equipment location trends and asset usage trends with the customer opportunity score to output a geographic location for a drop-box. In some embodiments, the plurality of factors can include at least one or more customer distances from the geographic location.

In some embodiments, a system for determining a suggested location for a drop-box includes one or more processors and one or more memory devices having stored thereon instructions that when executed by the one or more processors cause the one or more processors to: collect data from one or more sensors associated with equipment or one or more databases, determine equipment location trends and asset usage trends in a geographic area based on the data, determine a customer opportunity score for one or more pieces of equipment in a geographic area, and, using an algorithm with a plurality of factors, combine the equipment location trends and asset usage trends with the customer opportunity score to output a geographic location for a drop-box. In some embodiments, the plurality of factors can include at least one or more customer distances from the geographic location.

Other aspects will appear hereinafter. The features described herein can be used separately or together, or in various combinations of one or more of them.

### BRIEF DESCRIPTION OF THE DRAWINGS

The systems and methods described herein may be better understood by referring to the following Detailed Description in conjunction with the accompanying drawings, in which like reference numerals indicate identical or functionally similar elements:

FIG. 1 is a schematic illustration of a hypothetical dealer territory;

FIG. 2 is a schematic illustration of the hypothetical dealer territory, in which the customers are operating their equipment at remote worksites;

FIG. 3 is a flow diagram illustrating a method 300 for suggesting one or more drop-box locations;

FIG. 4 is a block diagram illustrating an overview of devices on which some implementations of the disclosed technology can operate;

FIG. 5 is a block diagram illustrating an overview of an environment 500 in which some implementations of the disclosed technology can operate; and

FIG. 6 is a block diagram illustrating elements which, in some embodiments, can be used in a system employing the disclosed technology.

The headings provided herein are for convenience only and do not necessarily affect the scope of the embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to unnecessarily limit the embodiments described. Rather, the embodiments are intended to cover all modifications, combinations, equivalents, and alternatives falling within the scope of this disclosure.

### DETAILED DESCRIPTION

Various embodiments of the present technology will now be described in further detail. The following description provides specific details for a thorough understanding and enabling description of these embodiments. One skilled in the relevant art will understand, however, that the techniques and technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description. Accordingly, embodiments of the present technology may include additional elements or exclude some of the elements described below with reference to the Figures, which illustrate examples of the technology.

The terminology used in this description is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such.

Disclosed are methods and systems for automatically suggesting drop-box locations by, in part, analyzing equipment location and/or usage trends, analyzing customer opportunities (for example, generating a customer opportunity score representative of profit potential), and performing a decision tree analysis or other analysis to determine a drop-box location that reduces (e.g., minimizes) customer travel time to the drop-box while increasing (e.g., maximizing) profit potential of the drop-box. Accordingly, systems and methods configured in accordance with embodiments of the present technology determine improved (e.g., optimal) locations for drop-boxes within a dealer's territory, and report those suggestions to a dealer.

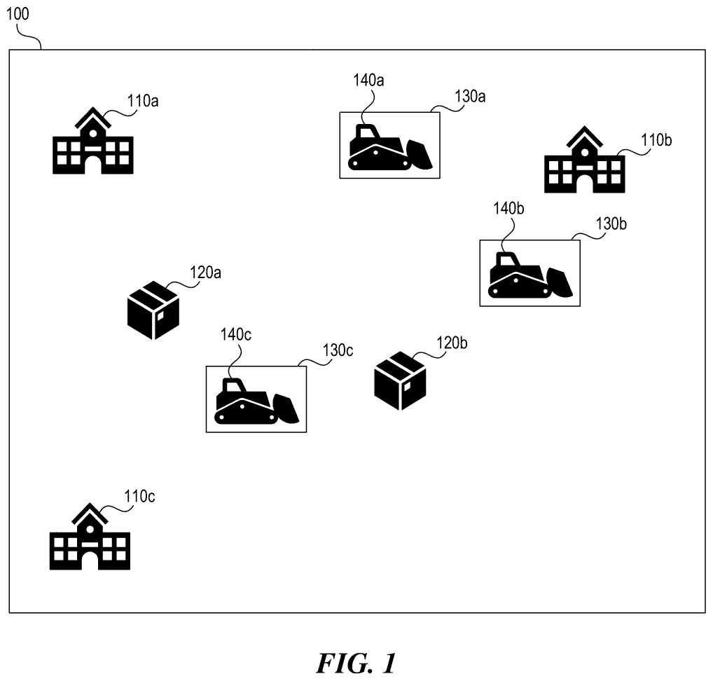

FIG. 1 is schematic map of a hypothetical dealer territory 100. The dealer may have one or more branch locations 110a, 110b, 110c within the territory 100. The branch locations 110a, 110b, 110c can include services for sales, parts, maintenance, and/or other activities. The dealer may also operate one or more drop-boxes 120a, 120b for customers to retrieve new parts and/or trade old parts, and/or for other purposes. The drop-boxes 120a, 120b may be replenished and/or otherwise serviced overnight by the dealer for a customer to access on a following day, and/or at other times. FIG. 1 also shows customer office locations 130a, 130b, 130c, where each customer may store and/or maintain corresponding equipment 140a, 140b, 140c.

A dealer may select locations for the drop-boxes 120a, 120b based on simply positioning the drop-boxes 120a, 120b in an area that is generally near the customer office locations 130a, 130b, 130c, to minimize travel time for a customer to receive and/or exchange parts. For example, in FIG. 1, customer office location 140a is approximately equidistant from dealer locations 110a and 110b, and from drop-boxes 120a, 120b, allowing the customer to select from multiple convenient locations. The other customers at their respective office locations 140b, 140c have similar convenience. However, such manual selection of locations time-consuming for dealers and does not optimize travel time or profit. In addition, customers may not always be operating and/or maintaining their equipment 140a, 140b, 140c at the respective customer office locations 130a, 130b, 130c. Rather, customers may operate and/or maintain equipment at remote worksites.

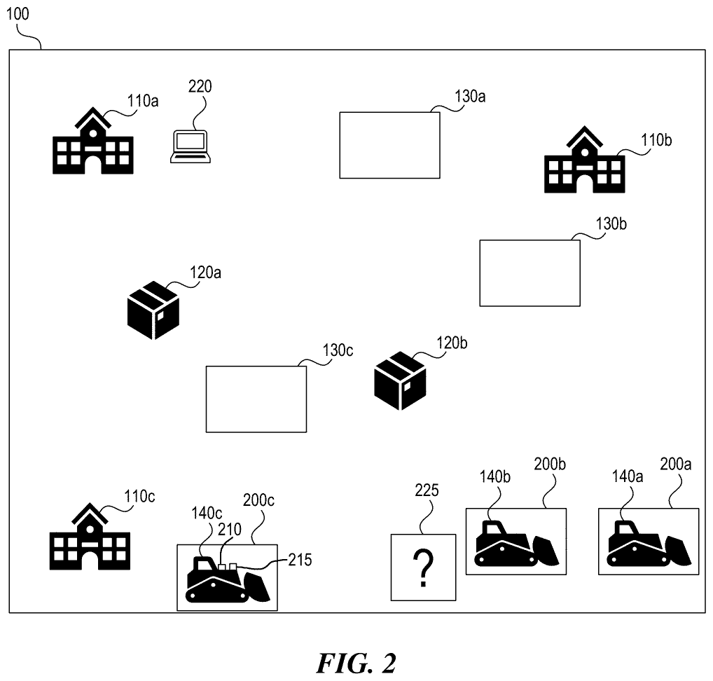

For example, FIG. 2 is a schematic map of the hypothetical dealer territory 100, in which the customers are operating their equipment 140a, 140b, 140c at respective worksites 200a, 200b, 200c. The worksites 200a, 200b, 200c are remote from the customer office locations 130a, 130b, 130c. Worksites can include roads, buildings, or other locations where equipment is used. Under these circumstances, the equipment 140a, 140b, 140c may not be conveniently located near a drop-box 120a, 120b. For example, the equipment 140a at worksite 200a is far from the drop-boxes 120a, 120b and far from the branch locations 110a, 110b, 110c. If the equipment 140a needs on-site repair at worksite 200a, the customer has a large travel distance to obtain parts. Because the remote worksites 200a, 200b, 200c are different from the customer office locations 130a, 130b, 130c and because they may change over time, locations for suitable drop-boxes may also change over time.

Systems and methods according to embodiments of the present technology analyze various aspects of equipment (such as the equipment 140a, 140b, 140c) to determine one or more locations for temporary or permanent drop-boxes. Information can include location, movement, usage, fault codes, status (such as fuel and/or tire status), and/or other factors. Accordingly, in some embodiments, each piece of equipment 140a, 140b, 140c includes one or more sensors 210 and one or more communication devices 215 for transmitting information (data) from the sensors 210. For simplicity in illustration, only equipment 140c is illustrated as having a sensor 210 and a communication device 215, but it is understood that each piece of equipment can include one or more such sensors and/or communication devices. The sensors 210 can include location sensors (such as global positioning system sensors or other location sensors), equipment usage trackers (e.g., sensors that quantify hours of equipment usage), equipment status sensors (e.g., sensors for detecting faults or fault codes, fuel consumption, or other aspects of the equipment), and/or other suitable sensors for gathering telematics related to the equipment 140a, 140b, 140c. A system embodying the present technology can further include one or more receiving computers 220 positioned to receive information from the communication devices 215 and the sensors 210. The one or more receiving computers 220 can be positioned in any suitable location.

In some embodiments, systems and methods include collecting data on movement of equipment 140a, 140b, 140c over time, along with data regarding customer purchases, to compute one or more potential (e.g., optimized) locations for drop-boxes that minimize customer travel distance. The drop-box locations may also increase revenues due to the additional convenience and additional potential usage of the drop-boxes. After determining a potential drop-box location, systems and methods according to embodiments of the present technology provide the dealers with the potential locations. For example, the systems and methods may determine that a location 225 is a suitable new location for a drop-box based on its proximity to equipment 140a, 140b, and 140c.

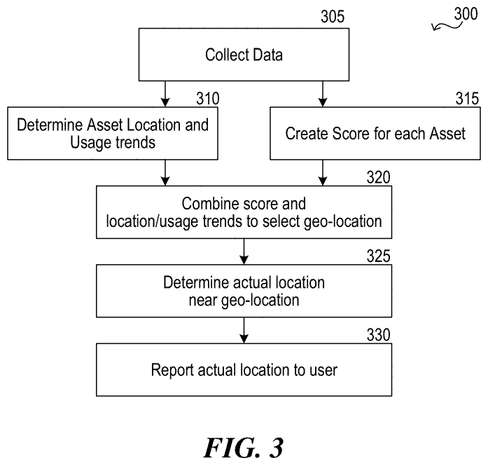

FIG. 3 is a flow diagram illustrating a method 300 for suggesting one or more drop-box locations. Beginning at step 305, the one or more receiving computers 220 collects various data. In some embodiments, data can include one or more of:
a. Customer purchase history, which may be organized by specific part, equipment using the part, and/or other suitable factors, and which may come from a database;
b. Historic and/or current pricing for parts, which may include a metric for profitability of each part, and which may come from a database;
c. Telematics, such as equipment usage (e.g., in hours), geographic location (including distances from existing drop-boxes and/or branch locations), movement, equipment fault codes, historical movement patterns, fuel consumption, and/or other metrics related to equipment status and operation, which may be gathered by the one or more sensors 210 and transmitted to the one or more receiving computers 220;
d. Loyalty scores for customers based on customer surveys and/or estimates of customer part and/or equipment purchases relative to competitors, which may come from a database; and/or
e. Other metrics, such as equipment usage severity scores (e.g., a metric of how hard a customer uses equipment) and/or future estimates of opportunities based on current usage.

The data can be stored in one or more databases associated with the one or more receiving computers 220. The data can be retrieved from the one or more databases by a processor or another aspect of the one or more receiving computers 220.

Next, at step 310, the method includes determining asset (equipment) location trends and usage trends based on equipment location data from the one or more sensors 210. In some embodiments, the equipment location trends are based on the equipment model, movement patterns of the equipment, a quantity of equipment in the same general location (“clustering”), and/or usage trends such as hours and/or fuel usage. In some embodiments, the location trends may be represented as a score or another suitable metric. Other factors that influence the location trends can include the type of equipment (smaller models typically relate to smaller, less profitable jobs and/or equipment) and the quantity of equipment in operation. The location and usage trends may be determined for the equipment regardless of the customer. In other words, in some embodiments, the location and usage trends are determined without regard to which customer owns the equipment. In some embodiments, the location and usage trend data is generated only for usage that exceeds a threshold. For example, a small project involving only one piece of equipment for a short time may be ignored because the project is not ongoing and does not need drop-box access.

At step 315, which may be performed before, after, or concurrent with step 310, the one or more receiving computers 220 and/or another processor determines a customer opportunity score for each asset (piece of equipment). In some embodiments, the one or more computers 220 determines each score based on potential parts consumption, profits, and/or other data (metrics) described above.

At step 320, the one or more receiving computers 220 perform an algorithm that combines the location and usage trends determined in step 310 with the customer opportunity score determined in step 315 to output a geographic location for a drop-box, such as the location 225 described above with regard to FIG. 2. The method determines the location to improve (e.g., optimize) customer drive time and parts sales and profitability. Accordingly, a factor in the algorithm can include the equipment distance from the geographic location for the drop-box. Other factors can include equipment usage in hours and/or fuel consumption of the equipment, which may correlate with parts needs and profit potential. Accordingly, in some embodiments, the method includes weighing the geographic location of heavily used equipment more than the geographic location of lesser-used equipment to select a profitable drop-box location.

In some embodiments, the drop-box may be positioned at the geographic location determined in step 320. However, depending on geographic circumstances, the determined location may be on inaccessible property, such as property owned by a third party or lacking access to roadways. Accordingly, in optional step 325, the method can further include determining an actual location near the geographic location.

The actual location can include a parking lot, gas station, service station, convenience store, or another nearby location and/or business that is suitable for a drop-box (e.g., accessible via truck or other vehicle and/or having suitable operating hours). In some embodiments, the method can include predetermining candidate locations that are suitable for the actual location. In other embodiments, the method can include searching an internet-based database and/or map for nearby candidate locations. Using a decision tree or other suitable algorithm, the one or more computers 220 selects one or more potential actual locations that are closest to the geographic location. At step 330, the method includes reporting the one or more potential actual locations to a user. In some embodiments, the one or more computers 220 select several actual locations and report those several actual locations to a user for the user to contact the property owners of the actual location to negotiate positioning of the drop-box.

In some embodiments, the method includes ranking the actual locations based on factors such as ease of access, opportunity for profit, and/or other factors. In other embodiments, the method includes reporting one actual location to the user, wherein the owner of the location has provided pre-approval for positioning a drop-box. A dealer can permanently or temporarily position a drop-box at the actual location and monitor the success of the drop-box to determine if and/or when it may need to be relocated by repeating the method using the one or more computers 220.

### Suitable System

The techniques disclosed herein can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to cause a computer, a microprocessor, processor, and/or microcontroller (or other electronic devices) to perform a process. The machine-readable medium may include, but is not limited to, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

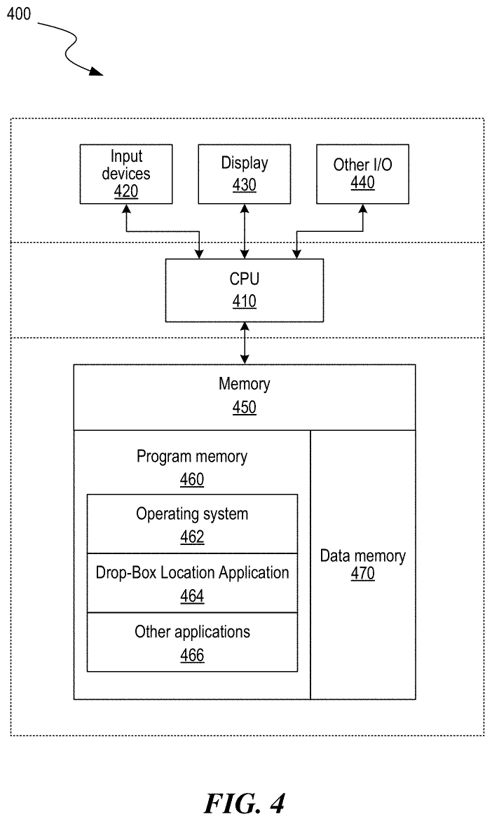

Several implementations are discussed below in more detail in reference to the figures. FIG. 4 is a block diagram illustrating an overview of devices on which some implementations of the disclosed technology can operate. The devices can comprise hardware components of a system 400 (which can be a device or a combination of devices, or another suitable system) that determines a suggested geographic location for a drop-box and/or a suggested actual location for a drop-box. The system 400 can include one or more input devices 420 that provide input to the CPU (processor) 410, notifying it of actions. The actions are typically mediated by a hardware controller that interprets the signals received from the input device and communicates the information to the CPU 410 using a communication protocol. Input devices 420 include, for example, a mouse, a keyboard, a touchscreen, an infrared sensor, a touchpad, a wearable input device, a camera- or image-based input device, a microphone, or other user input devices.

CPU 410 can be a single processing unit or multiple processing units in a device or distributed across multiple devices. CPU 410 can be coupled to other hardware devices, for example, with the use of a bus, such as a PCI bus or SCSI bus. The CPU 410 can communicate with a hardware controller for devices, such as for a display 430. Display 430 can be used to display text and graphics. In some examples, display 430 provides graphical and textual visual feedback to a user. In some implementations, display 430 includes the input device as part of the display, such as when the input device is a touchscreen or is equipped with an eye direction monitoring system. In some implementations, the display is separate from the input device. Examples of display devices are: an LCD display screen; an LED display screen; a projected, holographic, or augmented reality display (such as a heads-up display device or a head-mounted device); and so on. Other I/O devices 440 can also be coupled to the processor, such as a network card, video card, audio card, USB, FireWire or other external device, sensor, camera, printer, speakers, CD-ROM drive, DVD drive, disk drive, or Blu-Ray device.

In some implementations, the system 400 also includes a communication device (optionally, as one of the Other I/O devices 440) capable of communicating wirelessly or wire-based with a network node. The communication device can communicate with another device or a server through a network using, for example, TCP/IP protocols. System 400 can utilize the communication device to distribute operations across multiple network devices.

The CPU 410 can have access to a memory 450. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 450 can include program memory 460 that stores programs and software, such as an operating system 462, Drop-Box Location Application 464 (which may include instructions for carrying out the methods of determining drop-box locations disclosed herein), and other application programs 466. Memory 450 can also include data memory 470 that can include database information, etc., which can be provided to the program memory 460 or any element of the system 400.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, mobile phones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

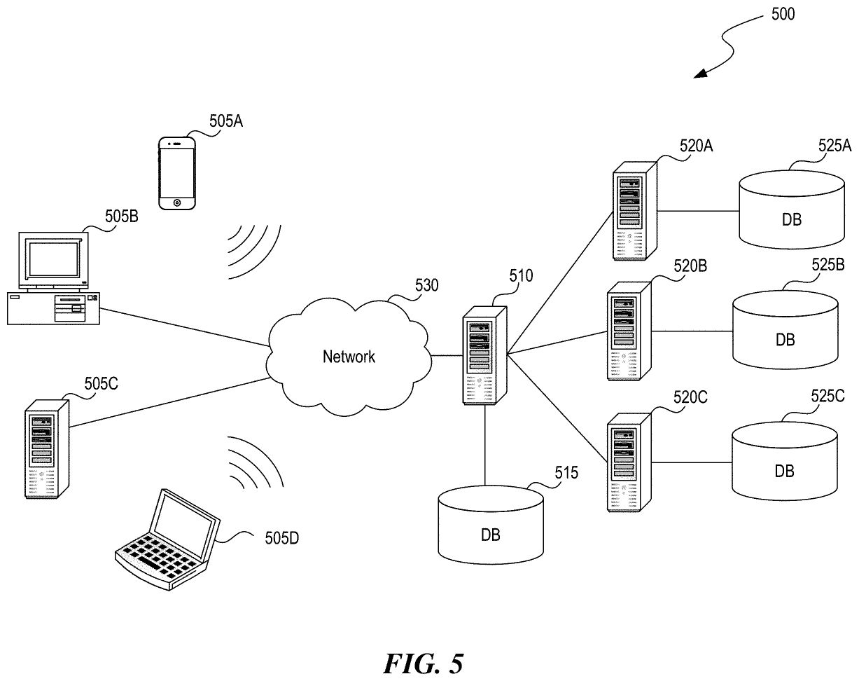

FIG. 5 is a block diagram illustrating an overview of an environment 500 in which some implementations of the disclosed technology can operate. Environment 500 can include one or more client computing devices 505A-D, examples of which can include the system 400 (which can be embodied in a device and/or combination of devices). Client computing devices 505 can operate in a networked environment using logical connections through network 530 to one or more remote computers, such as a server computing device 510.

In some implementations, server computing device 510 can be an edge server that receives client requests and coordinates fulfillment of those requests through other servers, such as servers 520A-C. Server computing devices 510 and 520 can comprise computing systems, such as the system 400. Though each server computing device 510 and 520 is displayed logically as a single server, server computing devices can each be a distributed computing environment encompassing multiple computing devices located at the same or at geographically disparate physical locations. In some implementations, each server computing device 520 corresponds to a group of servers.

Client computing devices 505 and server computing devices 510 and 520 can each act as a server or client to other server/client devices. Server 510 can connect to a database 515. Servers 520A-C can each connect to a corresponding database 525A-C. Each server 520 can correspond to a group of servers, and each of these servers can share a database or can have their own database. Databases 515 and 525 can warehouse (e.g., store) information. Though databases 515 and 525 are displayed logically as single units, databases 515 and 525 can each be a distributed computing environment encompassing multiple computing devices, can be located within their corresponding server, or can be located at the same or at geographically disparate physical locations.

Network 530 can be a local area network (LAN) or a wide area network (WAN), but can also be other wired or wireless networks. Network 530 may be the Internet or some other public or private network. Client computing devices 505 can be connected to network 530 through a network interface, such as by wired or wireless communication. While the connections between server 510 and servers 520 are shown as separate connections, these connections can be any kind of local, wide area, wired, or wireless network, including network 530 or a separate public or private network.

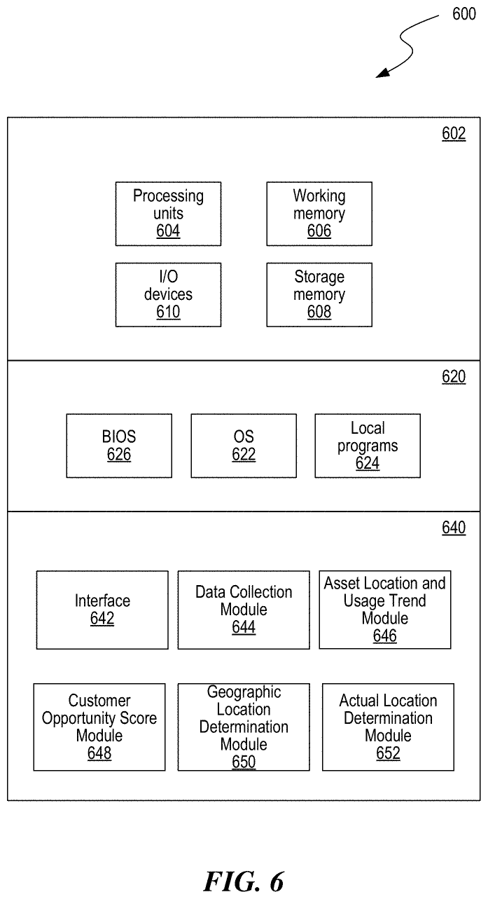

FIG. 6 is a block diagram illustrating elements 600 which, in some implementations, can be used in a system employing the disclosed technology. The elements 600 include hardware 602, general software 620, and specialized elements 640. As discussed above, a system implementing the disclosed technology can use various hardware, including processing units 604 (e.g., CPUs, GPUs, APUs, etc.), working memory 606, storage memory 608, and input and output devices 610. Elements 600 can be implemented in a client computing device such as client computing devices 505 or on a server computing device, such as server computing device 510 or 520.

General software 620 can include various applications, including an operating system 622, local programs 624, and a basic input output system (BIOS) 626. Specialized components 640 can be subcomponents of a general software application 620, such as local programs 624, which may include the Drop-Box Location Application 464 (see FIG. 4 and description above). Specialized elements 640 can include a Data Collection Module 644, an Asset Location and Usage Trend Module 646, a Customer Opportunity Score Module 648, a Geographic Location Determination Module 650, an Actual Location Determination Module 652, and components that can be used for transferring data and controlling the specialized components, such as an interface 642. In some implementations, elements 600 can be in a computing system that is distributed across multiple computing devices or can be an interface to a server-based application executing one or more of specialized elements 640.

Those skilled in the art will appreciate that the components illustrated in FIGS. 4-6 described above, and in each of the flow diagrams discussed above, may be altered in a variety of ways. For example, the order of the logic may be rearranged, sub steps may be performed in parallel, illustrated logic may be omitted, other logic may be included, etc. In some implementations, one or more of the components described above can execute one or more of the processes described herein.

### INDUSTRIAL APPLICABILITY

In some embodiments, systems for suggesting drop-box locations can include the Data Collection Module 644, the Asset Location and Usage Trend Module 646, the Customer Opportunity Score Module 648, the Geographic Location Determination Module 650, and the Actual Location Determination Module 652 (FIG. 6).

In operation, the Data Collection Module 644 collects various data associated with step 305 in FIG. 3, such as customer purchase history, pricing, telematics, loyalty scores, or other metrics. The Data Collection Module 644 causes the various data to be stored in the one or more databases associated with the one or more receiving computers 220. The Asset Location and Usage Trend Module 646 determines asset (equipment) location trends and usage trends based on equipment location data from the one or more sensors 210 (see step 310 in FIG. 3). The Customer Opportunity Score Module 648 determines a customer opportunity score for each asset (piece of equipment), as explained above regarding step 315 in FIG. 3. The Geographic Location Determination Module 650 combines the location and usage trends from the Asset Location and Usage Trend Module 646 with the customer opportunity score from the Customer Opportunity Score Module 648 to determine and output a geographic location for a drop-box (see step 320 in FIG. 3). The Actual Location Determination Module 652 determines an actual location near the geographic location (see step 325 in FIG. 3). In some embodiments, the Geographic Location Determination Module 650 and/or the Actual Location Determination Module 652 include decision tree algorithms and/or other suitable algorithms.

General software 620 may include instructions to repeat one or more, or even all of the steps of the method 300 (see FIG. 3) at selected increments of time to continually or periodically update suggested locations for drop-boxes. In some embodiments, the method 300 may include repeating steps 305-330 when sensor data indicates movement of equipment beyond a pre-determined threshold (which may indicate that a customer is moving to a new remote worksite, for example).

The disclosed technology, therefore, automatically determines suggested (e.g., optimal) locations for drop-boxes based on the location of equipment, usage of equipment, maintenance status of equipment, profit potential for equipment, and/or other factors. Generally, the disclosed technology determines suggested (e.g., optimal) drop-box locations to minimize average customer travel time to access the drop-boxes.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” (or the like) in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

As used herein, the term “and/or” when used in the phrase “A and/or B” means “A, or B, or both A and B.” A similar manner of interpretation applies to the term “and/or” when used in a list of more than two terms.

What is claimed is:

1. A method of determining a suggested location for a drop-box, the method comprising:
collecting data from one or more sensors or databases;
determining equipment location trends and asset usage trends in a geographic area based on the data;
determining a customer opportunity score for one or more pieces of equipment in a geographic area; and
using an algorithm with a plurality of factors, combining the equipment location trends and asset usage trends with the customer opportunity score to output a geographic location for a drop-box, wherein the plurality of factors includes at least customer distance from the geographic location.

2. The method of claim 1, wherein the data comprises at least one of:
customer purchase history;
part prices;
equipment usage in hours;
geographic location of equipment; or
movement of equipment.

3. The method of claim 1, wherein the equipment location trends include a metric representative of a quantity of equipment in a geographic location.

4. The method of claim 1, wherein the equipment usage trends include data indicative of a type of the equipment.

5. The method of claim 1, wherein determining the customer opportunity score comprises determining the score based on parts consumption by the equipment or profit data associated with the parts.

6. The method of claim 1, wherein the plurality of factors includes equipment usage in hours or fuel consumption, and wherein the algorithm gives more weight to more heavily-used equipment than to lesser-used equipment.

7. The method of claim 1, further comprising determining an actual location that is near the geographic location, wherein determining the actual location comprises selecting the actual location from a database of pre-selected locations or analyzing a map.

8. A system for determining a suggested location for a drop-box, the system comprising:
one or more processors; and
one or more memory devices having stored thereon instructions that when executed by the one or more processors cause the one or more processors to:
collect data from one or more sensors associated with equipment or one or more databases;
determine equipment location trends and asset usage trends in a geographic area based on the data;
determine a customer opportunity score for one or more pieces of equipment in a geographic area; and
using an algorithm with a plurality of factors, combine the equipment location trends and asset usage trends with the customer opportunity score to output a geographic location for a drop-box, wherein the plurality of factors includes at least customer distance from the geographic location.

9. The system of claim 8, wherein the data comprises at least one of:
customer purchase history;
part prices;
equipment usage in hours;
geographic location of equipment; or
movement of equipment.

10. The system of claim 8, wherein the equipment location trends include a metric representative of a quantity of equipment in a geographic location.

11. The system of claim 8, wherein the equipment usage trends include data indicative of a type of the equipment.

12. The system of claim 8, wherein determining the customer opportunity score comprises determining the score based on parts consumption by the equipment or profit data associated with the parts.

13. The system of claim 8, further comprising determining an actual location that is near the geographic location, wherein determining the actual location comprises selecting the actual location from a database of pre-selected locations or analyzing a map.

14. One or more non-transitory computer-readable media storing computer-executable instructions that, when executed by one or more processors, cause the one or more processors to perform operations comprising:
collecting data from one or more sensors or databases;
determining equipment location trends and asset usage trends in a geographic area based on the data;
determining a customer opportunity score for one or more pieces of equipment in a geographic area; and
using an algorithm with a plurality of factors, combining the equipment location trends and asset usage trends with the customer opportunity score to output a geographic location for a drop-box, wherein the plurality of factors includes at least customer distance from the geographic location.

15. The media of claim 14, wherein the data comprises at least one of:
customer purchase history;
part prices;
equipment usage in hours;
geographic location of equipment; or
movement of equipment.

16. The media of claim 14, wherein the equipment location trends include a metric representative of a quantity of equipment in a geographic location.

17. The media of claim 14, wherein the equipment usage trends include data indicative of a type of the equipment.

18. The media of claim 14, wherein determining the customer opportunity score comprises determining the score based on parts consumption by the equipment or profit data associated with the parts.

19. The media of claim 14, wherein the plurality of factors includes equipment usage in hours or fuel consumption, and wherein the algorithm gives more weight to more heavily-used equipment than to lesser-used equipment.

20. The media of claim 14, wherein the instructions further cause the one or more processors to determine an actual location that is near the geographic location, wherein determining the actual location comprises selecting the actual location from a database of pre-selected locations or analyzing a map.
